(19) United States
(12) Patent Application Publication
(10) Pub. No.: US 2015/0032915 A1
(43) Pub. Date: Jan. 29, 2015

(54) STORAGE SYSTEM INCLUDING DATA TRANSFER SPEED MANAGER AND METHOD FOR CHANGING DATA TRANSFER SPEED THEREOF

(71) Applicant: SAMSUNG ELECTRONICS CO., LTD., SUWON-SI (KR)

(72) Inventors: JEONG HUR, DONG-GU (KR); SANGYOON OH, SUWON-SI (KR); YOUNGMOON KIM, SUWON-SI (KR); JEONG-WOO PARK, SUWON-SI (KR); HYUNSOO CHO, BUCHEON-SI (KR)

(73) Assignee: SAMSUNG ELECTRONICS CO., LTD., SUWON-SI (KR)

(21) Appl. No.: 14/293,965

(22) Filed: Jun. 2, 2014

(30) Foreign Application Priority Data
Jul. 25, 2013 (KR) 10-2013-0088111

(51) Int. Cl. G06F 5/06

(52) U.S. Cl. CPC G06F 5/06
USPC 710/29

(57) ABSTRACT

A storage system according to an exemplary embodiment of the inventive concept includes a host and a storage device. The host includes a link speed table having data transfer speed information for an application. A data transfer speed manager is configured to calculate a predetermined transfer speed based on the data transfer speed information for the application. A device driver is configured to control an operation of the storage device. A host controller is configured to change a data transfer speed of an interface based on the predetermined transfer speed provided through the device driver.

### CROSS-REFERENCE TO RELATED APPLICATIONS

This non-provisional U.S. application claims priority under 35 U.S.C. §119 to Korean Patent Application No. 10-2013-0088111 filed Jul. 25, 2013, in the Korean Intellectual Property Office, the disclosure of which is incorporated by reference herein in its entirety.

### TECHNICAL FIELD

Exemplary embodiments of the inventive concept relate to a storage system, and more particularly, to a storage system including a data transfer speed manager and a method for changing a data transfer speed of the storage system.

### DISCUSSION OF RELATED ART

A storage system includes a host and a storage device. The host and the storage device are interconnected through various interfaces such as a Universal Flash Storage (UFS) interface, a Serial ATA (SATA) interface, a Small Computer Small Interface SCSI), a Serial Attached SCSI (SAS), an embedded MMC (eMMC), etc.

A trade-off may exist between the performance and power consumption of the storage system. For example, as a data transfer speed increases, the performance and the power consumption both may increase, and vice versa.

The storage system may unnecessarily consume power by sending data at an excessively high speed.

### SUMMARY

An exemplary embodiment of the inventive concept is directed to provide a host of a storage system. The host comprises a link speed table having data transfer speed information for an application. A data transfer speed manager is configured to calculate a predetermined transfer speed based on the data transfer speed information for the application. A device driver is configured to control an operation of a storage device. A host controller is configured to change a data transfer speed of an interface based on the predetermined transfer speed provided through the device driver.

In an exemplary embodiment of the inventive concept, the data transfer speed manager receives the data transfer speed information of the application and applies the data transfer speed information of the application to the link speed table.

In an exemplary embodiment of the inventive concept, the data transfer speed manager measures the amount of data of the application transferred per unit time, calculates the predetermined transfer speed based on the amount of data transferred and applies the predetermined transfer speed to the link speed table.

In an exemplary embodiment of the inventive concept, the data transfer speed manager calculates a predetermined transfer speed on a per-speed basis. When the application is terminated and a second application is executed, the data transfer speed manager calculates a second predetermined transfer speed for the second application. When the application and the second application are terminated, the data transfer speed manager turns a state of the interface into a sleep state.

A storage system according to an exemplary embodiment of the inventive concept comprises a storage device based on a flash memory. A host is connected to the storage device through an interface. The host is configured to transfer data to the storage device. The host changes a data transfer speed between the host and the storage device according to an application.

In an exemplary embodiment of the inventive concept, the host comprises a link speed table configured to manage data transfer speed information for the application. The host further comprises a data transfer speed manager. The data transfer speed manager is configured to receive the data transfer speed information for the application when the application is installed and is configured to apply the data transfer speed information for the application to the link speed table.

In an exemplary embodiment of the inventive concept, the data transfer speed manager calculates a predetermined transfer speed for the application by measuring the transfer amount of data that the application transmits and receives per unit time and applies the predetermined transfer speed to the link speed table. The data transfer speed manager calculates a predetermined transfer speed on a per-speed basis. The data transfer speed manager changes the data transfer speed on a per-class basis.

In an exemplary embodiment of the inventive concept, when the application is terminated and a second application is executed, the data transfer speed manager changes the data transfer speed according to the second application. When the application is terminated, the data transfer speed manager turns a state of the interface into a sleep state.

In an exemplary embodiment of the inventive concept, when the application and a second application are running, the data transfer speed manager calculates a predetermined transfer speed by summing the data transfer speed according to the application and a data transfer speed according to the second application. The data transfer speed manager sets an interface speed to a data transfer speed supported by the storage device according to the type of the storage device.

An exemplary embodiment of the inventive concept is related to a method of changing a data transfer speed of a storage system that includes a host and a storage device. In the method, identification information of an application is received. A predetermined transfer speed is calculated based on the identification information and a link speed table. A device driver is requested to change a data transfer speed to the predetermined transfer speed. A data transfer speed of an interface is changed in response to the predetermined transfer speed provided through the device driver.

In an exemplary embodiment of the inventive concept, the method further comprises updating the link speed table with data transfer speed information for the application provided from the application when the application is installed.

In an exemplary embodiment of the inventive concept, the method further comprises, after the application is terminated, calculating a predetermined transfer speed according to a second application. When the application and the second application are terminated, the data transfer speed manager turns a state of the interface into a sleep state.

In an exemplary embodiment of the inventive concept, the method further comprises setting an interface speed to a data transfer speed supported by the storage device according to the type of the storage device.

According to an exemplary embodiment of the present invention, a method of changing a data transfer speed between a host and a storage device comprises receiving data transfer speed information on an application from a link speed table. A predetermined data transfer speed is calculated based on the data transfer speed information. The data transfer speed between the host and the storage device is changed to the predetermined transfer speed.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating a storage system according to an exemplary embodiment of the inventive concept;

FIG. 2 is a block diagram illustrating a flash memory based UFS system according to an exemplary embodiment of the inventive concept;

FIG. 3 is a timing diagram illustrating a program procedure of an UFS system illustrated in FIG. 2, according to an exemplary embodiment of the inventive concept;

FIGS. 4 to 6 are timing diagrams illustrating reduction of a peak power when a data transfer speed is slower, according to an exemplary embodiment of the inventive concept;

FIG. 7 is a block diagram illustrating a storage system according to an exemplary embodiment of the inventive concept;

FIG. 8 is a block diagram illustrating a method in which a storage system illustrated in FIG. 7 changes a data transfer speed, according to an exemplary embodiment of the inventive concept;

FIG. 9 is a flow chart illustrating a data transfer speed changing method of a storage system illustrated in FIG. 8, according to an exemplary embodiment of the inventive concept;

FIGS. 10 and 11 are block diagrams illustrating an efficient transfer speed calculating method of a data transfer speed manager illustrated in FIG. 8, according to an exemplary embodiment of the inventive concept;

FIG. 12 is a graph illustrating a method of calculating an efficient transfer speed when the number of running applications is changed by lapse of time, according to an exemplary embodiment of the inventive concept;

FIG. 13 is a block diagram for describing a method in which a host controller illustrated in FIG. 8 changes a data transfer speed, according to an exemplary embodiment of the inventive concept;

FIG. 14 shows a method in which a data transfer speed manager illustrated in FIG. 8 manages a link speed table by a file unit smaller than an application unit, according to an exemplary embodiment of the inventive concept;

FIG. 15 is a block diagram illustrating a storage system in which a host is connected to a plurality of storage devices, according to an exemplary embodiment of the inventive concept; and

FIG. 16 is a table illustrating a data transfer speed changing method of a storage system illustrated in FIG. 15, according to an exemplary embodiment of the inventive concept.

### DETAILED DESCRIPTION OF EXEMPLARY EMBODIMENTS

Exemplary embodiments will be described in detail with reference to the accompanying drawings. The inventive concept, however, may be embodied in various different forms, and should not be construed as being limited only to the illustrated embodiments. like reference numerals may denote like or similar elements throughout the drawings and the specification.

As used herein, the singular forms “a”, “an” and “the” are intended to include the plural forms as well, unless the context clearly indicates otherwise.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

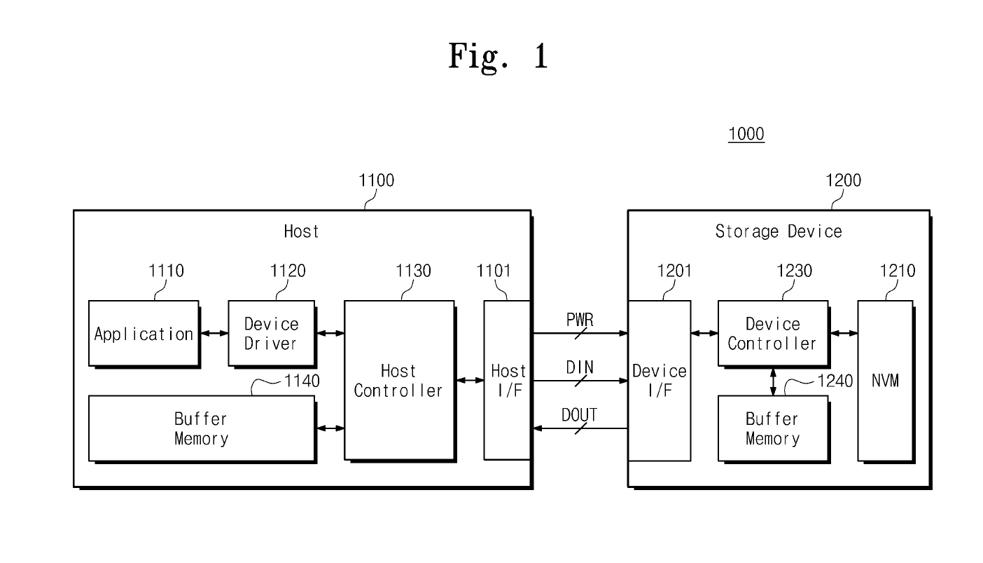

FIG. 1 is a block diagram illustrating a storage system according to an exemplary embodiment of the inventive concept. Referring to FIG. 1, a storage system 1000 includes a host 1100 and a storage device 1200. The host 1100 and the storage device 1200 may be interconnected through various standardized interfaces such as a Universal Flash Storage (UFS) interface, a Serial ATA (SATA) interface, a Small Computer Small Interface SCSI), a Serial Attached SCSI (SAS), an embedded MMC (eMMC) interface, etc.

Referring to FIG. 1, the host 1100 includes a host interface 1101, and the storage device 1200 includes a device interface 1201. The host interface 1101 and the device interface 1201 are connected with each other through data lines DIN and DOUT for exchanging data and signals and a power line PWR for providing power to the storage device 1200. The host 1100 further includes an application 1110, a device driver 1120, a host controller 1130, and a buffer memory 1140.

The application 1110 may be formed of application programs executed on the host 1100. The device driver 1120 drives peripheral devices connected to the host 1100. For example, the device driver 1120 may drive the storage device 1200. The application 1110 and the device driver 1120 may be implemented by software or firmware. The host controller 1130 provides data to the storage device 1200 through the host interface 1101 and receives data from the storage device 1200 through the host interface 1101.

The buffer memory 1140 may be used as a main memory or a cache memory of the host 1100. The buffer memory 1140 may be used as a driving memory for driving software such as the application 1100, the device driver 1120, etc.

The storage device 1200 is connected to the host 1100 through the device interface 1201. The storage device 1200 further includes a nonvolatile memory (NVM) 1210, a device controller 1230, and a buffer memory 1240.

The nonvolatile memory 1210 may include a flash memory, a Magnetic RAM (MRAM), a Phase change RAM (PRAM), a Ferroelectric RAM (FRAM, F-RAM, or FeRAM), etc. The device driver 1230 controls an overall operation of the nonvolatile memory 1210 including a write operation, a read operation, an erase operation, etc. The device controller 1230 exchange data with the nonvolatile memory 1210 or the buffer memory 1240 through an address or data bus.

The buffer memory 1240 temporarily stores data to be stored in the nonvolatile memory 1210 or data read from the nonvolatile memory 1210. The buffer memory 1240, for example, may be formed of a volatile memory, a nonvolatile memory, or a combination of the volatile and nonvolatile memories.

The storage system 1000 illustrated in FIG. 1 consumes a lot of power at an interface where the host 1100 and the storage device 1200 are interconnected. When mass data such as a moving picture is transferred between the host 1100 and the storage device 1200 at high speed, power consumption at the interface may increase.

Supply of power or a clock to a module may be stopped when the module is not used, reducing power consumption. The storage system 1000 consumes a lot of power while the nonvolatile memory 1210 transmits data.

A trade-off may exist between the performance and power consumption of the storage system 1000. For example, as data transfer speed increases, the performance and power consumption increase. When data transfer speed decreases, the performance and the power consumption decrease. A conventional storage system sends data at a maximum speed which satisfies the host 1100 and the storage device 1200. In this case, the storage system 1000 may unnecessarily consume power.

The storage system 1000 illustrated in FIG. 1 is applicable to a flash memory-based mobile device or another electronic device.

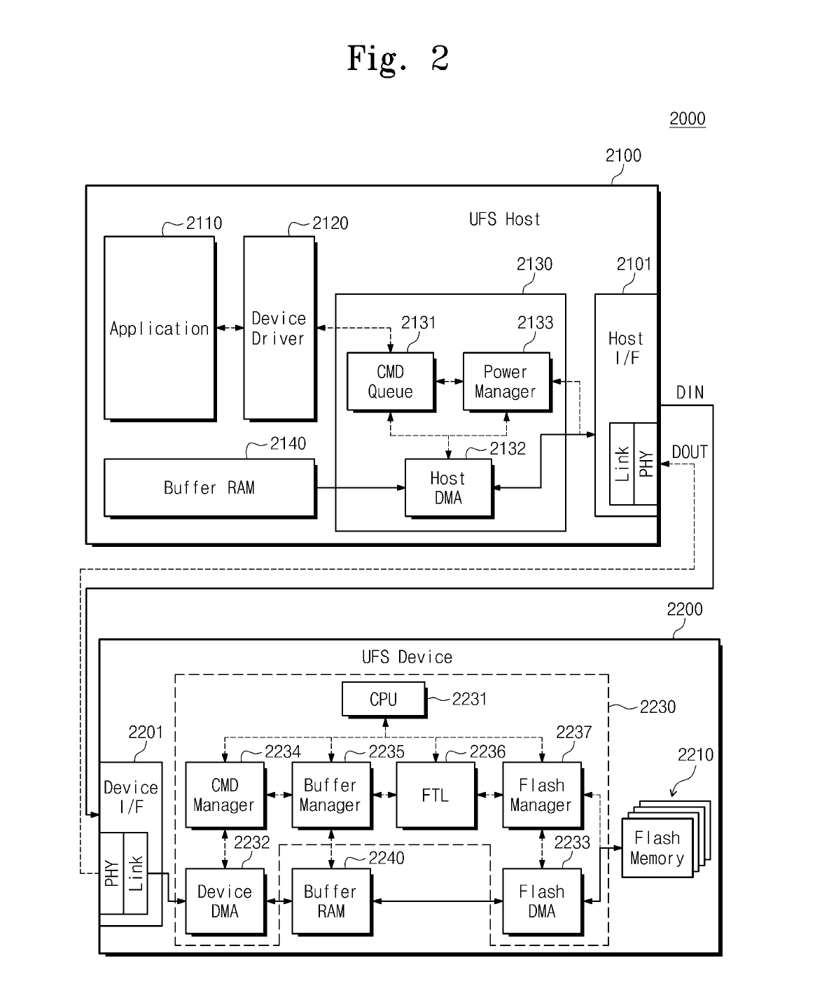

FIG. 2 is a block diagram illustrating a flash memory based universal flash storage (UFS) system according to an exemplary embodiment of the inventive concept. Referring to FIG. 2, an UFS system 2000 includes an UFS host 2100 and an UFS device 2200.

The UFS host 2100 includes an application 2110, a device driver 2120, a host controller 2130, and a buffer RAM 2140. The host controller 2130 includes a command queue 2131, a host DMA 2132, and a power manager 2133.

A command (e.g., a write command) generated by the application 2110 and the device driver 2120 in the UFS host 2100 is provided to the command queue 2131 of the host controller 2130. The command queue 2131 sequentially stores commands provided from the UFS device 2200. The command stored in the command queue 2131 is provided to the host DMA 2132. The host DMA 2132 sends the command to the UFS device 2200 through a host interface 2101.

The UFS device 2200 includes a flash memory 2210, a device controller 2230, and a buffer RAM 2240. The device controller 2230 includes a Central Processing Unit (CPU) 2231, a device DMA 2232, a flash DMA 2233, a command manager 2234, a buffer manager 2235, a flash translation layer 2236, and a flash manager 2237.

A command transferred from the UFS host 2100 to the UFS device 2200 is provided to the device DMA 2232 through a device interface 2201. The device DMA 2232 transfers the input command to the command manager 2234. The command manager 2234 allocates the buffer RAM 2240 to receive data through the buffer manager 2235. When the command manager 2234 is ready to transfer data, the command manager 2234 sends RTT (READY_TO_TRANSFER) UPIU to the UFS host 2100.

The UFS host 2100 sends data to the UFS device 2200 in response to the RTT UPIU. The data is sent to the UFS device 2200 through the host DMA 2132 and the host interface 2101. The UFS device 2200 stores the received data in the buffer RAM 2240 through the device DMA 2232 and the buffer manager 2235. The data stored in the buffer RAM 2240 is provided to the flash manger 2237 through the flash DMA 2233. The flash manager 2237 stores data at an address of the flash memory 2210 based on address mapping table of the flash translation layer 2236.

When a data transfer needed for a command and programming end, the UFS device 2200 sends a response to the UFS host 2100 through the interface and informs the UFS host 2100 that a command is completed. The UFS host 2100 informs the device driver 2120 and the application 2110 of whether a received command is completed, based on a response signal, and the UFS host 2100 terminates an operation on a corresponding command.

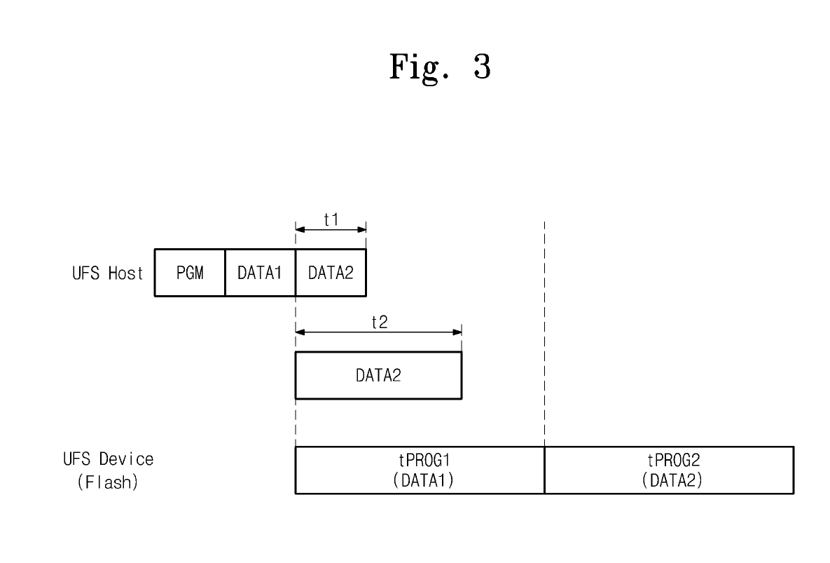

FIG. 3 is a timing diagram illustrating a program procedure of an UFS system illustrated in FIG. 2, according to an exemplary embodiment of the inventive concept. Referring to FIG. 3, an UFS host 2100 (refer to FIG. 2) provides a program command PGM and first and second data DATA1 and DATA2 to an UFS device 2200 (refer to FIG. 2). The UFS device 2200 performs a program operation on the first and second data DATA1 and DATA2 in response to the program command PGM. The first data DATA1 is programmed during a first program time tPROG1, and the second data DATA2 is programmed during a second program time tPROG2.

Referring to FIGS. 2 and 3 the UFS host 2100 sends the first data DATA1, and the UFS device 2200 temporarily stores the first data DATA1 in a buffer memory 2240. The UFS device 2200 programs the first data, which has been temporarily stored in the buffer memory 2240, in the flash memory 2210. The flash memory 2210 programs the first data DATA1 during the first program time tPROG1, for example.

After programming the first data DATA1 ends, the UFS device 2200 performs a program operation on the second data DATA2. The UFS device 2200 programs the second data DATA2, which has been temporarily stored in the buffer memory 2240, in the flash memory 2210. The flash memory 2210 programs the second data DATA2 during the second program time tPROG2, for example.

As illustrated in FIG. 3, when the UFS host 2100 sends the first data DATA1, the flash memory 2210 programs the first data DATA1. The UFS host 2100 provides the second data DATA2 to the UFS device 2200 while programming the first data DATA1 in the flash memory 2210.

Referring to FIG. 3, the program time tPROG1 when the flash memory 2210 programs the first data DATA1 is longer than a time t1 when the UFS host 2100 sends the second data DATA2. For the purpose of description, a time taken for the UFS host 2100 to transfer the second data DATA2 is changed from t1 to t2. In this case, since the second data DATA2 is transferred during an idle time in the first program time tPROG1, the performance of the UFS system 2000 might not be influenced. The UFS system 2000 reduces a peak power by increasing a data transfer time. Thus, heat and power consumption may be reduced.

A trade-off may exist between a data transfer speed and a peak power. For example, the peak power increases when the data transfer speed increases, and the peak power decreases when the data transfer speed decreases. As shown in FIG. 3, a second transfer time t2 of the second data DATA2 is longer than a first transfer time t1. A peak power and heat are reduced by changing a transfer time of the second data DATA2 from the first transfer time t1 to the second transfer time t2.

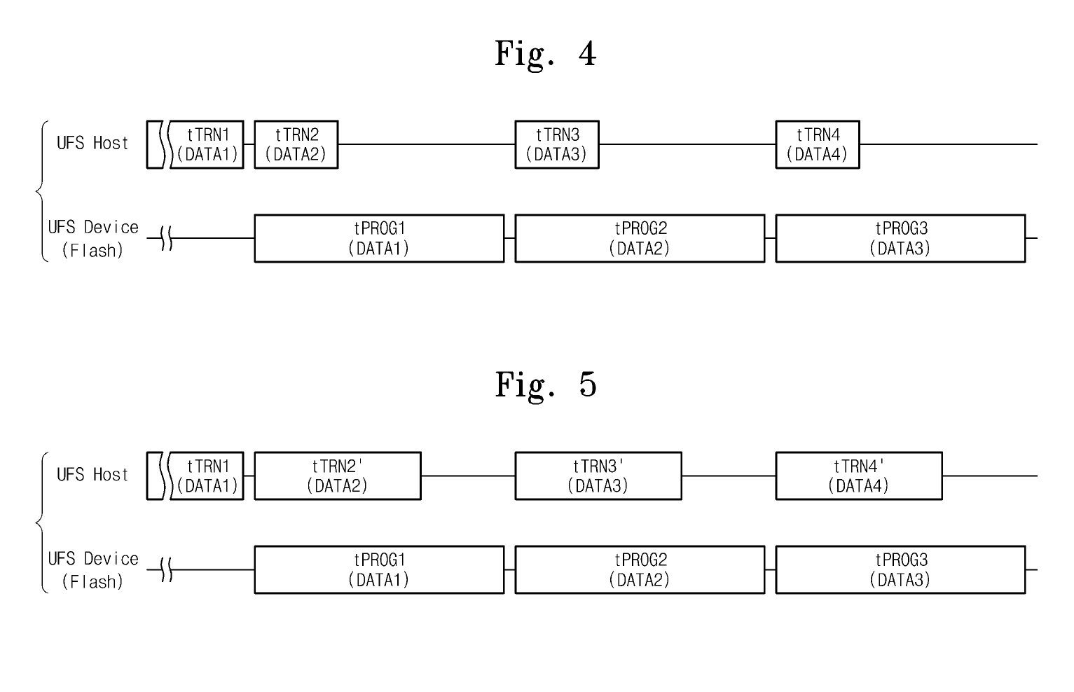

FIGS. 4 to 6 are timing diagrams illustrating an example in which a peak power decreases when a data transfer speed is reduced. Data is transferred slower in the structure illustrated in FIG. 5 than in the structure illustrated in FIG. 4. For example, in the structure shown in FIG. 4, data is transferred relatively at a high speed, and in the structure shown in FIG. 5, data is transferred relatively at a low speed.

Referring to FIG. 4, an UFS host 2100 sends first data DATA1 for a first transfer time tTRN1. When the transfer of the first data DATA1 ends, an UFS device 2200 programs the first data DATA1 in a flash memory 2210. The flash memory 2210 performs a program operation on the first data DATA1 for a first program time tPROG1.

While the flash memory 2210 programs the first data DATA1, the UFS host 2100 transfers second data DATA2 for a second transfer time tTRN2. The UFS host 2100 transfers third data DATA3 for a third transfer time tTRN3 and transfers fourth data DATA4 for a fourth transfer time tTRN4. The flash memory 2210 performs a program operation on the second data DATA2 for a second program time tPROG2 and performs a program operation on the third data DATA3 for a third program time tPROG3.

Referring to FIG. 5, the UFS host 2100 sends the first data DATA1 for the first transfer time tTRN1 and the second data DATA2 for a second transfer time tTRN2′. The second transfer time tTRN2′ illustrated in FIG. 5 is longer than the second transfer time tTRN2 illustrated in FIG. 4. For example, the UFS host 2100 illustrated in FIG. 4 sends the second data DATA2 relatively slower than the UFS host 2100 illustrated in FIG. 5. Third and fourth transfer times tTRN3′ and tTRN4′ illustrated in FIG. 5 are longer than the third and fourth transfer times tTRN3 and tTRN4, respectively, illustrated in FIG. 4.

The UFS system 2000 according to an exemplary embodiment of the inventive concept reduces a peak power by increasing a data transfer time in the same program time (e.g., tPROG1). For example, a peak power may be reduced by decreasing a data transfer speed.

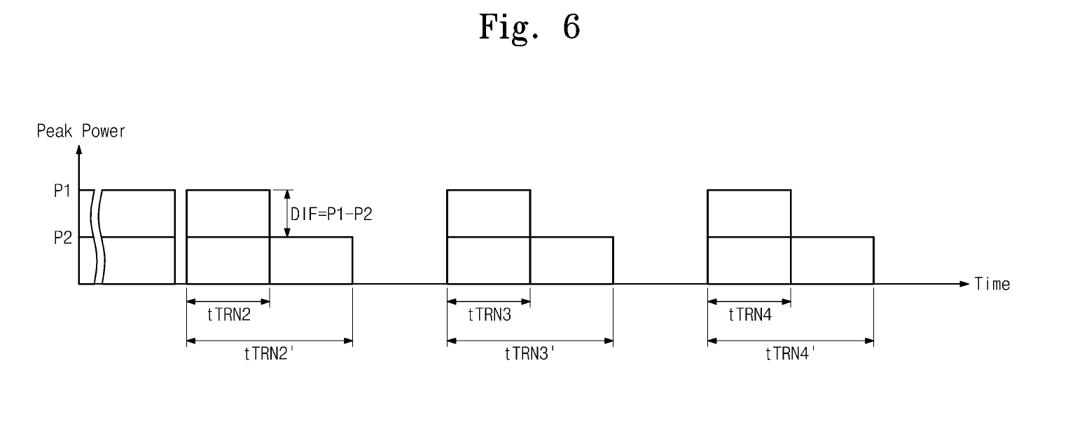

Referring to FIG. 6, a peak power P2 generated for the second transfer time tTRN2′ is smaller than a peak power P1 generated for the second transfer time tTRN2. The peak power is decreased when a data transfer time increases or a data transfer speed decreases. As shown in FIG. 6, a peak power is reduced by DIF (=P1−P2).

A storage system according to an exemplary embodiment of the inventive concept changes a data transfer speed. In this case, a system performance is maintained, while a peak power and heat are reduced. According to an exemplary embodiment of the inventive concept, a means for adjusting a data transfer speed between a host and a storage device is provided.

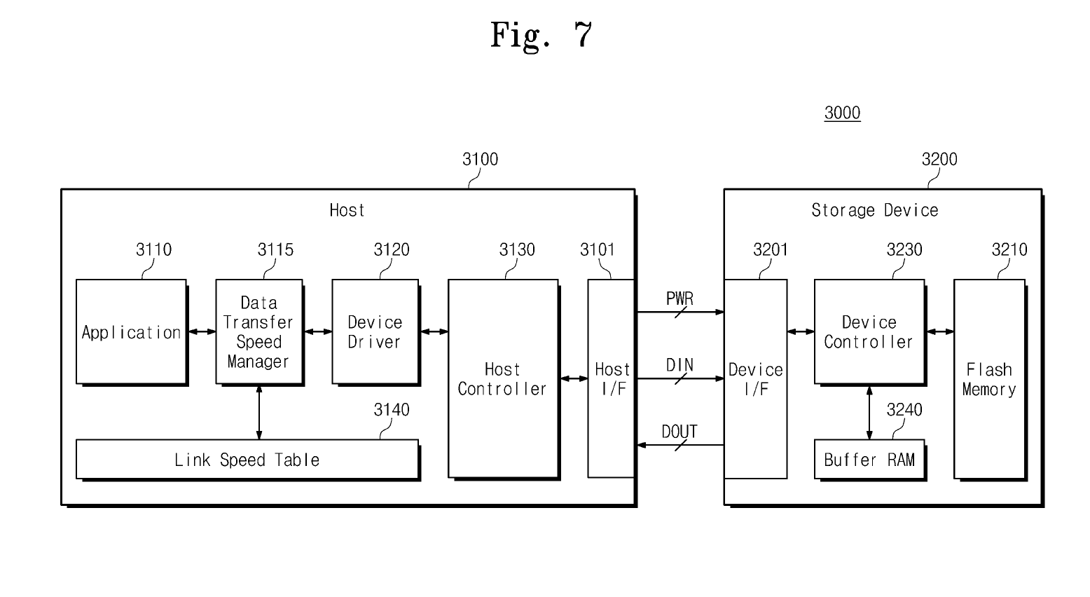

FIG. 7 is a block diagram illustrating a storage system according to an exemplary embodiment of the inventive concept. Referring to FIG. 7, a storage system 3000 includes a host 3100 and a storage device 3200. A host interface 3101 and a device interface 3201 are connected with each other through data lines DIN and DOUT and a power line PWR.

Referring to FIG. 7, the host 3100 includes an application 3110, a data transfer speed manager 3115, a device driver 3120, a host controller 3130, and a link speed table 3140.

Each application program of the application 3110 has a link speed or a data transfer speed needed for data transmission or reception. For example, an application A needs a transmit speed Tx of 1 Gbps for data transmission and a receive speed Rx of 1.5 Gbps for data reception. Information on the transmit speed and receive speed of the application 3110 is managed using the link speed table 3140.

The data transfer speed manager 3115 may be implemented by hardware, software, firmware, or a combination thereof. The data transfer speed manager 3115 receives identification information of the application 3110 running and calculates an efficient transfer speed of an interface using speed information of the link speed table 3115.

The efficient transfer speed is provided to the host controller 3130 through the device driver 3120. The host controller 3130 changes data transfer speeds of the host and device interfaces 3101 and 3201 based on the efficient transfer speed.

Data transfer speed information of the application 3110 is managed using the link speed table 3140. The link speed table 3140 may obtain data transfer speed information using the following methods.

When the application 3110 is installed, the data transfer speed manager 3115 may receive data transfer speed information from the application 3110. The data transfer speed manager 3115 manages the data transfer speed information using the link speed table 3140. The information provided from the application 3110 includes a transmit speed Tx and a receive speed Rx.

The data transfer speed manager 3115 measures the amount of data transfer of the application 3110 per unit time and calculates an efficient transfer speed based on the amount of data transfer thus measured. The data transfer speed manager 3115 continues to measure the amount of data transfer per unit time and updates the link speed table 3140 based on the measurement result. In this case, since a data transfer speed is measured based on an actual user pattern, the data transfer speed may be managed more efficiently.

A data transfer speed unit managed by the link speed table 3140 may be the amount of data transfer (e.g., 50 Mbps, 840 Mpbs, etc.) that the application 3110 requires. The data transfer speed unit may be expressed using speed classes such as Class1, Class2, . . . , ClassN (N is a positive integer).

The storage device 3200 includes a flash memory device 3210, a device controller 3230, and a buffer memory 3240. The device driver 3230 controls an overall operation of the flash memory 3210 including a write operation, a read operation, an erase operation, etc. The device controller 3230 exchange data with the flash memory 3210 or the buffer memory 3240 through an address or data bus.

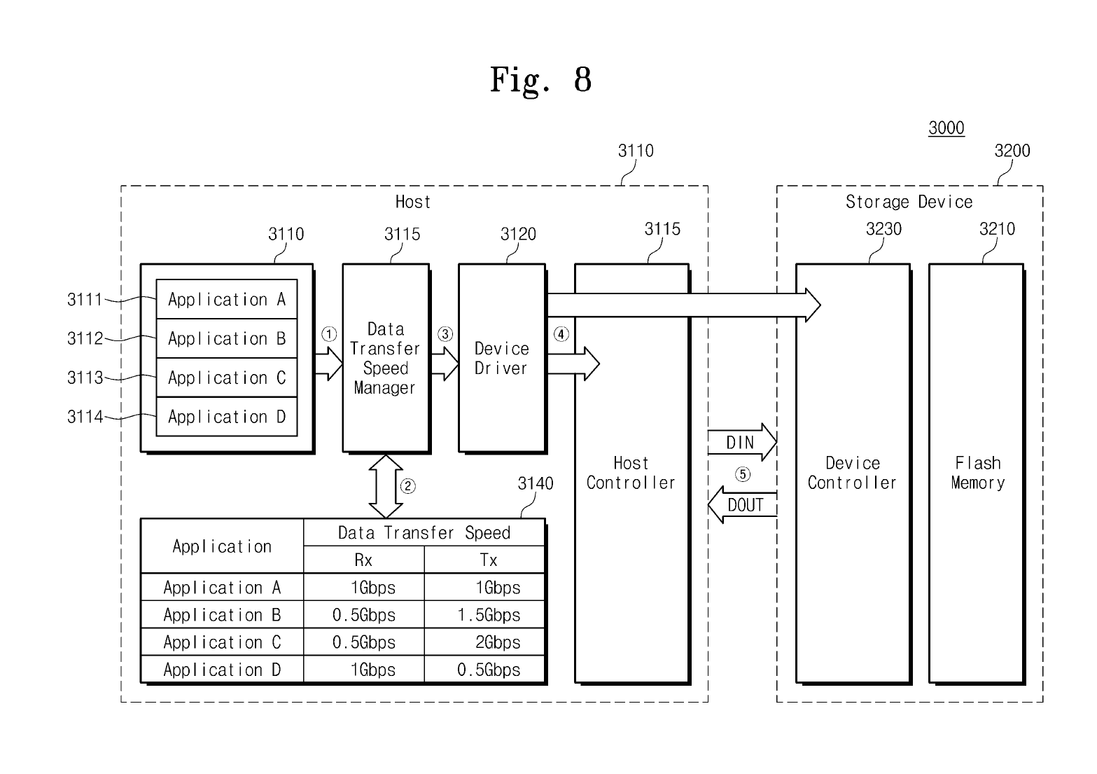

FIG. 8 is a block diagram illustrating a method in which a storage system illustrated in FIG. 7 changes a data transfer speed. Referring to FIG. 8, an application 3110 of a host 3100 includes a first application A 3111 to a fourth application D 3114 installed as application programs.

Each application has transmit and receive speeds Tx and Rx needed for an operation. For example, the application A 3111 needs a transmit speed Tx of 1 Gbps and a receive speed Rx of 1 Gbps, and the application B 3112 needs a transmit speed Tx of 0.5 Gbps and a receive speed Rx of 1.5 Gbps. The application C 3113 needs a transmit speed Tx of 0.5 Gbps and a receive speed Rx of 2 Gbps, and the application D 3114 needs a transmit speed Tx of 1 Gbps and a receive speed Rx of 0.5 Gbps. Data transfer speed information of each application may be managed using a link speed table 3140.

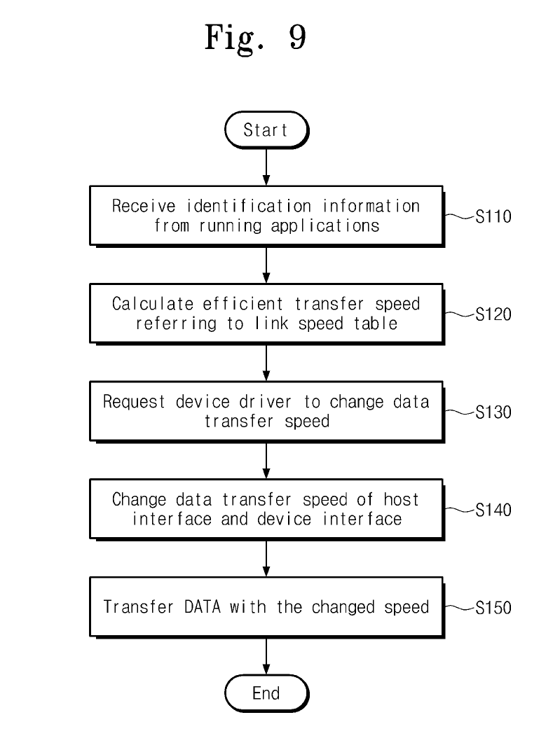

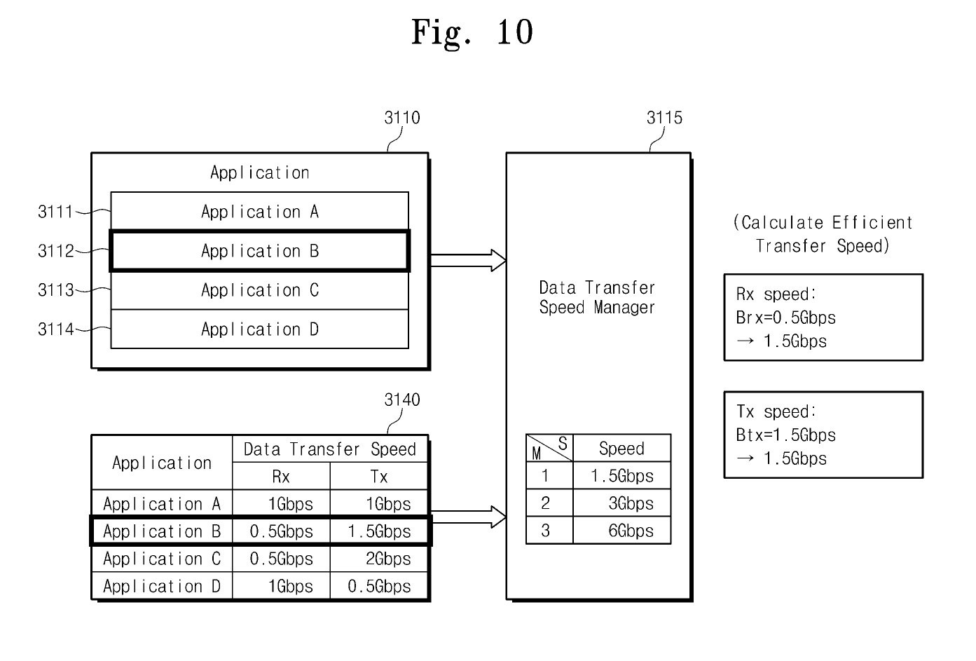

FIG. 9 is a flow chart illustrating a method of changing a data transfer speed of a storage system illustrated in FIG. 8, according to an exemplary embodiment of the inventive concept.

In step S110, a data transfer speed manager 3115 receives from identification information from a running application. For example, when an application B 3112 runs, the data transfer speed manager 3115 may receive identification information of the application B 3112 (\textcircled{1}).

In step S120, the data transfer speed manager 3115 calculates an efficient transfer speed based on a link speed table 3140. For example, the data transfer speed manager 3115 obtains a data transfer speed of the application B 3112 from the link speed table 3140, based on the identification information of the application B 3112 (\textcircled{2}).

The data transfer speed manager 3115 calculates an efficient transfer speed using data transfer speeds Rx and Tx of the application B 3112. The efficient transfer speed may mean such a speed that a peak power is reduced while a system performance is maintained without variation. The data transfer speed manager 3115 predetermines a configurable data transfer speed.

For example, the data transfer speed manager 3115 calculates an efficient transfer speed to be one of three speeds of 1.5 Gbps, 3 Gbps, and 6 Gbps. The data transfer speed manager 3115 calculates an efficient transfer speed to be 1.5 Gbps when a transfer speed is 0.5 Gbps. The data transfer speed manager 3115 calculates an efficient transfer speed to be 3 Gbps when a transfer speed is 2 Gbps.

In step S130, the data transfer speed manager 3115 sends a request for changing a data transfer speed to the calculated efficient transfer speed to a device driver 3120 (\textcircled{3}).

In step S140, the device driver 3120 issues a command directing a change of a data transfer speed to a host controller 3130. A host controller 3130 changes a data transfer speed of an interface in response to a speed change command (\textcircled{4}).

In step S150, a host 3100 and a storage device 3200 exchange data at the changed speed (\textcircled{5}).

A storage system according to an exemplary embodiment of the inventive concept changes a transfer speed of data exchanged between the host 3100 and the storage device 3200. For example, a transfer time tTRN2 of second data DATA2 illustrated in FIG. 4 is changed to a transfer time tTRN2′ illustrated in FIG. 5. As a data transfer speed is changed, the performance of the system is maintained and a peak power and heat are reduced.

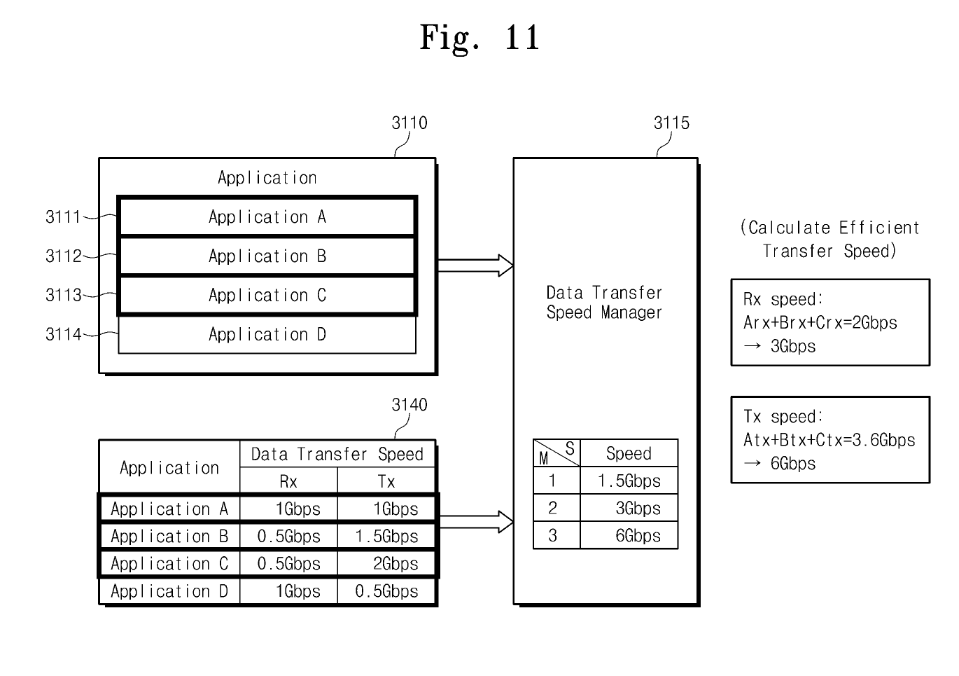

FIGS. 10 and 11 are block diagrams illustrating a method of calculating an efficient transfer speed of a data transfer speed manager illustrated in FIG. 8, according to an exemplary embodiment of the inventive concept. FIG. 10 shows an embodiment where an application B 3112 is running. In FIGS. 10 and 11, for purposes of description, a data transfer speed manager 3115 has three speed modes of 1.5 Gbps, 3 Gbps, and 6 Gbps.

Referring to FIG. 10, the data transfer speed manager 3115 obtains a data transfer speed of the application B 3112 from a link speed table 3140, based on identification information of the application B 3112 running. Referring to a link speed table 3140, the application B 3112 has a receive speed Brx of 0.5 Gbps and a transmit speed Btx of 1.5 Gbps. The data transfer speed manager 3115 calculates an efficient transfer speed by selecting one of three speed modes of 1.5 Gbps, 3 Gbps, and 6 Gbps.

For example, when a receive speed Brx of the application B 3112 is 0.5 Gbps, the data transfer speed manager 3115 calculates the efficient transfer speed to be 1.5 Gbps. Likewise, when a transmit speed Btx of the application B 3112 is 1.5 Gbps, the data transfer speed manager 3115 calculates the efficient transfer speed to be 1.5 Gbps.

Referring to FIG. 11, three applications are running. The data transfer speed manager 3115 obtains data transfer speeds on the applications 3111 to 3113 from a link speed table 3140, based on identification information of the applications 3111 to 3113 running. The data transfer speed manager 3115 calculates the efficient transfer speed by summing transfer speeds of the applications 3111 to 3113.

For example, since receive speeds Arx, Brx, and Crx of the applications 3111 to 3113 are 1.5 Gbps, 0.5 Gbps, and 0.5 Gbps, respectively, the data transfer speed manager 3115 obtains a receive speed of 2 Gbps by summing the receive speeds Arx, Brx, and Crx of the applications 3111 to 3113. The data transfer speed manager 3115 calculates an efficient receive speed of 3 Gbps using a receive speed of 2 Gbps.

Likewise, the data transfer speed manager 3115 obtains a transmit speed of 3.6 Gbps by summing transmit speeds Atx, Btx, and Ctx of the applications 3111 to 3113. The data transfer speed manager 3115 calculates an efficient receive speed of 6 Gbps using a transmit speed of 3.6 Gbps.

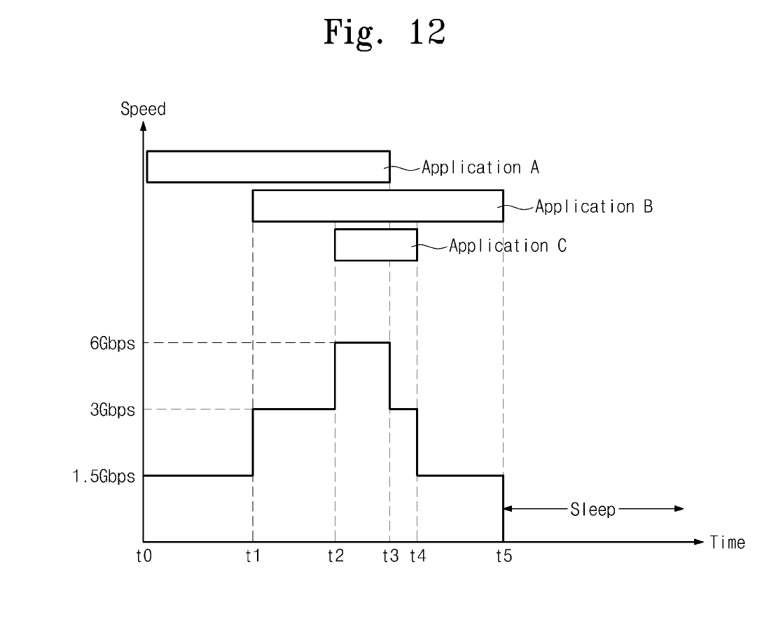

FIG. 12 is a graph illustrating a method of calculating an efficient transfer speed when the number of running applications is changed over time, according to an exemplary embodiment of the inventive concept. Referring to FIG. 12, an application A is running during a time section between t0 and t3, an application B is running during a time section between t1 and t5, and an application C is running during a time section between t2 and t4. A data transfer speed manager 3115 calculates an efficient transfer speed based on a link speed table 3140 whenever an application is changed.

Referring to FIG. 12, the application A is running during a time section between t0 and t1. The data transfer speed manager 3115 calculates an efficient transfer speed of the application A, thus determining a data transfer speed of 1.5 Gbps. The applications A and B run during a time section between t1 and t2. The data transfer speed manager 3115 calculates efficient transfer speeds of the applications A and B, determining a data transfer speed of 3 Gbps.

The applications A to C run during a time section between t2 and t3. The data transfer speed manager 3115 calculates efficient transfer speeds of the applications A to C, determining a data transfer speed of 3 Gbps. The applications B and C run during a time section between t4 and t5, and a data transfer speed is changed to 1.5 Gbps.

There is no application that runs after t5. In this case, the data transfer speed manager 3115 minimizes power consumption by changing a state of an interface to a low power mode or a sleep state.

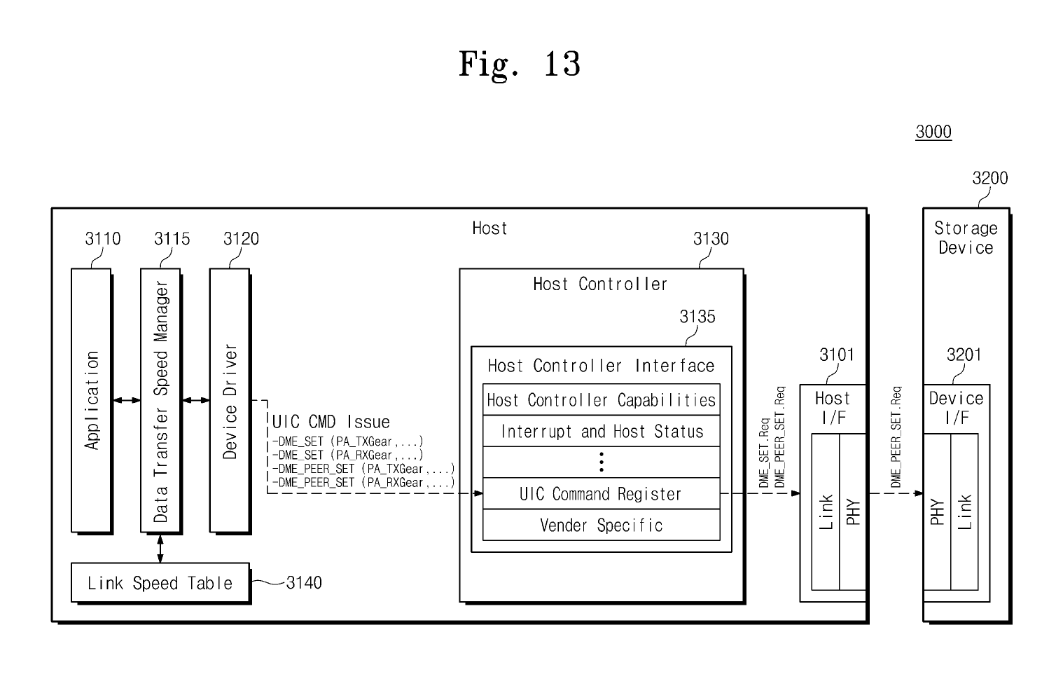

FIG. 13 is a block diagram for describing a method in which a host controller illustrated in FIG. 8 changes a data transfer speed, according to an exemplary embodiment of the inventive concept. As shown in FIG. 13, a method of changing the data transfer speed of an UFS system is illustrated. Referring to FIG. 13, a device driver 3120 provides a Host Controller Interface (HCI) 3135 with an UFS interconnect layer command (UIC) command (CMD) such as DME_Set, DME_PEER_SET, etc. The HCI 3135 includes Host Controller Capabilities, Interrupt and Host Status, . . . , UIC Command Register, and Vender Specific.

The UIC CMD is provided to an UIC command register. A host controller 3130 may change a data transfer speed by setting UIC attributes. When the UIC command register is set, the host controller 3130 provides DME_SET.Req and DME_PEER_SET.Req to a host interface 3101 and changes data transfer speeds of host and device interfaces 3101 and 3201.

The host interface 3101 and the device interface 3201 are formed of a link layer and a physical layer as the UFS interconnect layer (UIC). The link layer is called “MIPI UniPro”, and the physical layer is called “MIPI M-PHY”.

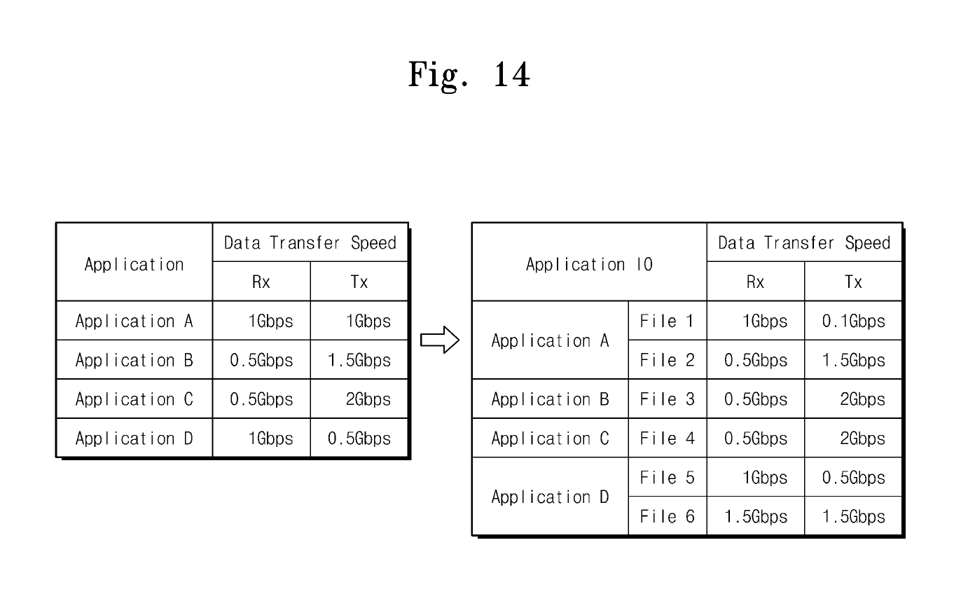

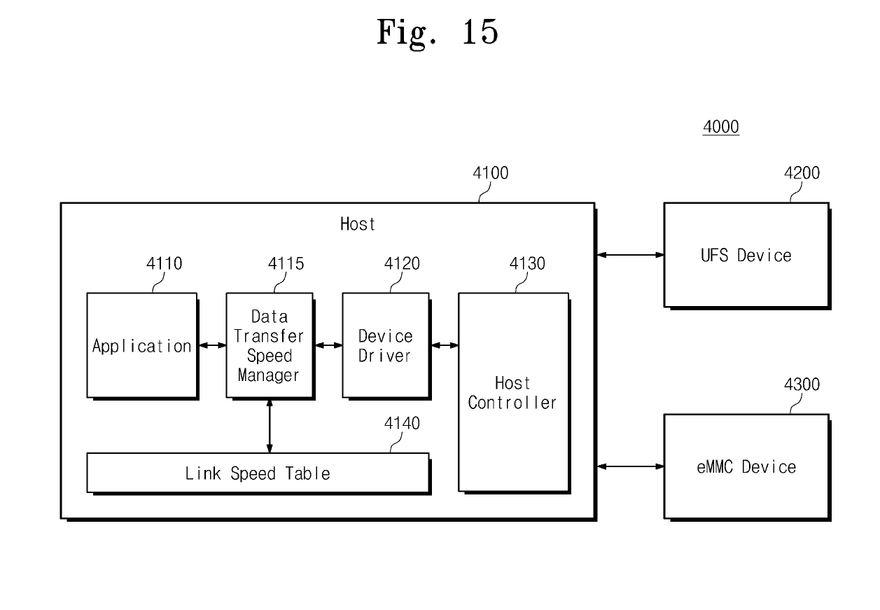

FIG. 14 shows a method in which a data transfer speed manager illustrated in FIG. 8 manages a link speed table on the basis of a file unit smaller than an application unit.

When an application 3110 provides transmit/receive speed information on a per-file unit basis, a data transfer speed manager 3115 expands a link speed table 3140 on a per-file unit basis. For example, an application A is expanded into a first file file1 and a second file file2, and an application D is expanded into a fifth file file5 and a sixth file file6.

When the application D is associated with a moving picture, the fifth file file5 may be a high definition (HD) moving picture and the sixth file file6 may be a full-HD moving picture. Referring to FIG. 14, the fifth file file5 of the application D has a receive speed Rx of 1 Gbps and a transmit speed Tx of 0.5 Gbps, and the sixth file file6 of the application D has a receive speed Rx of 1.5 Gbps and a transmit speed Tx of 1.5 Gbps.

A storage system 3000 according to an exemplary embodiment of the inventive concept controls a data transfer speed on the basis of a file unit smaller than an application unit.

FIG. 15 is a block diagram illustrating a storage system in which a host is connected to a plurality of storage devices, according to an exemplary embodiment of the inventive concept. Referring to FIG. 15, a host 4100 of a storage system 4000 is connected to a plurality of storage devices such as a Universal Flash Storage (UFS) device 4200 and an embedded MMC (eMMC) device 4300.

A data transfer speed manager 4115 calculates an efficient transfer speed of a running application 4110 based on a link speed table 4140 and provides the calculated efficient transfer speed to a device driver 4120. The device driver 4120 changes an efficient transfer speed to a speed mode suitable for a target storage device (e.g., the UFS device 4200 or the eMMC device 4300). A host controller 4130 changes a speed of an interface and transfers data at the changed speed.

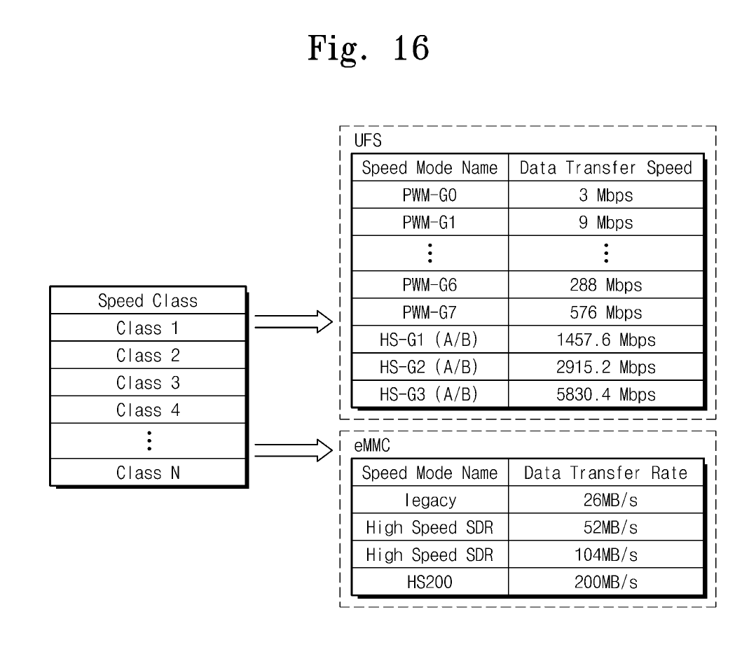

FIG. 16 is a table illustrating a method of changing a data transfer speed of a storage system illustrated in FIG. 15, according to an exemplary embodiment of the inventive concept. Referring to FIG. 16, a host 4100 sets a data transfer speed on a per-speed class basis.

When the host 4100 is connected to an UFS device 4200 having speed modes of ‘PWM-G0’, ‘PWM-G1’, . . . , ‘HS-G3(A/B)’, data transfer speeds may be set to 3 Mbps, 9 Mbps, . . . , 5830.4 Mbps, respectively. When the host 4100 is connected to an eMMC device 4300 having speed modes of ‘legacy’, ‘High Speed SDR’, ‘High Speed DDR’, and ‘HS200’, data transfer rates may be set to 26 MB/s, 52 MB/s, 104 MB/s, and 200 MB/s, respectively.

A storage system 4000 according to an exemplary embodiment of the inventive concept changes a data transfer speed/rate to correspond to a speed mode supported by a device that is connected to a host 4100. As illustrated in FIGS. 15 and 16, the inventive concept is applicable to an example where both an UFS device 4200 and an eMMC device 4300 are connected to the host 4100.

While the inventive concept has been described with reference to exemplary embodiments, it will be apparent to those skilled in the art that various changes and modifications may be made without departing from the spirit and scope of the inventive concept. For example, the spirit and scope of the inventive concept may not be limited to a flash memory device. For example, the spirit and scope of the inventive concept may be applied to all storage devices using address translation by a translation layer. Therefore, it should be understood that the above embodiments are not limiting, but illustrative.

What is claimed is:

1. A host of a storage system, comprising:
a link speed table having data transfer speed information for an application;
a data transfer speed manager configured to calculate a predetermined transfer speed based on the data transfer speed information for the application;
a device driver configured to control an operation of a storage device; and
a host controller configured to change a data transfer speed of an interface based on the predetermined transfer speed provided through the device driver.

2. The host of claim 1, wherein when the application is installed, the data transfer speed manager is configured to receive the data transfer speed information for the application and configured to apply the data transfer speed information of the application to the link speed table.

3. The host of claim 1, wherein the data transfer speed manager is configured to measure the amount of data of the application transferred per unit time, configured to calculate the predetermined transfer speed based on the amount of data transferred, and configured to apply the predetermined transfer speed to the link speed table.

4. The host of claim 1, wherein the data transfer speed manager is configured to calculate a predetermined transfer speed on a per-speed basis.

5. The host of claim 1, wherein when the application is terminated and a second application is executed, the data transfer speed manager is configured to calculate a second predetermined transfer speed for the second application.

6. The host of claim 5 wherein when the application and the second application are terminated, the data transfer speed manager is configured to turn the interface into a sleep state.

7. A storage system, comprising:
a storage device; and
a host connected to the storage device through an interface, the host configured to transfer data to the storage device,
wherein the host is configured to change a data transfer speed between the host and the storage device according to an application.

8. The storage system of claim 7, wherein the host comprises a link speed table configured to manage data transfer speed information for the application.

9. The storage system of claim 8, wherein the host further comprises:
a data transfer speed manager configured to receive the data transfer speed information for the application when the application is installed and configured to apply the data transfer speed information for the application to the link speed table.

10. The storage system of claim 9, wherein the data transfer speed manager is configured to calculate a predetermined transfer speed for the application by measuring the amount of data that the application transmits and receives per unit time and is configured to apply the predetermined transfer speed to the link speed table.

11. The storage system of claim 9, wherein the data transfer speed manager is configured to calculate a predetermined transfer speed on a per-speed basis.

12. The storage system of claim 9, wherein the data transfer speed manager is configured to change the data transfer speed on a per-class basis.

13. The storage system of claim 9, wherein when the application is terminated and a second application is executed, the data transfer speed manager is configured to change the data transfer speed according to the second application.

14. The storage system of claim 9, wherein when the application is terminated, the data transfer speed manager is configured to turn a state of the interface into a sleep state.

15. The storage system of claim 9, wherein when the application and a second application are running, the data transfer speed manager is configured to calculate a predetermined transfer speed by summing the data transfer speed according to the application and a data transfer speed according to the second application.

16. The storage system of claim 9, wherein the data transfer speed manager is configured to set an interface speed to a data transfer speed supported by the storage device according to the type of the storage device.

17. A method of changing a data transfer speed of a storage system that includes a host and a storage device, the method comprising:
receiving identification information of an application;
calculating a predetermined transfer speed based on the identification information and a link speed table;
requesting a device driver to change a data transfer speed of an interface to the predetermined transfer speed; and
changing the data transfer speed of the interface in response to the predetermined transfer speed provided through the device driver.

18. The method of claim 17, further comprising:
updating the link speed table with data transfer speed information for the application provided from the application when the application is installed.

19. The method of claim 17, further comprising:
after the application is terminated, calculating a predetermined transfer speed according to second application.

20. The method of claim 19, further comprising turning a state of the interface into a sleep state when the application and the second application are terminated.
